(19) United States
(12) Patent Application Publication
(10) Pub. No.: US 2014/0197284 A1
(43) Pub. Date: Jul. 17, 2014

(54) ANGLED PIPE CLAMP

(71) Applicant: Susumu Hikoyama, Tokyo (JP)

(72) Inventor: Susumu Hikoyama, Tokyo (JP)

(21) Appl. No.: 13/743,186

(22) Filed: Jan. 16, 2013

(51) Int. Cl. F16L 3/12

(52) U.S. Cl. CPC F16L 3/1211
USPC 248/74.1

(57) ABSTRACT

A pipe clamp with a first piece matingly connectable to a second piece where the first piece and the second piece have first ends configured for insertion into a channel and second ends configured to be connectable to each other where one of the second ends has a hole therethrough and the other second end has a threaded hole therethrough and where both the second ends are angled and where the second ends of the first piece and the second piece are matingly configured to be secured and attached to each other via the common hole and the threaded hole where the holes are matingly and angularly configured to align with each other and where a bolt is matingly configured to pass through the common hole and then screw into the threaded hole until the first and the second pieces are securely connected.

### BACKGROUND OF THE INVENTION

1. Field of the Invention

The present invention relates to a pipe clamp typically used for hangering and or mounting pipe or conduit. The pipe or conduit may be used for the transfer of electricity, water, air, fuel, or anything else that may be moved via pipe or conduit. Pipe or conduit will be used interchangeably throughout the remainder of this application as will clamp or hanger.

2. Description of the Related Art

Historically, conduit or pipe that conveys electricity, water or air is hung inside of a building using a hangar. These hangars, as shown in FIG. 1, are typically two separate pieces of metal that are joined together using a nut and a bolt. The pieces are generally identical in configuration and design. FIG. 1 shows a standard hangar as currently used in the industry. Each matching piece of the hangar has a hole through which the bolt is conveyed and then the nut is affixed to the bolt to join the two hangar pieces together. At the other end of the hangar pieces is a connector end that is typically placed and affixed in a C channel, a channel or unistrut. The end that is fitted to the channel has two end portions that together form a modified T that help secure the hangar to the channel. The pipe is placed between the two hangar pieces, the hangar pieces are placed within the channel, and then the opposite ends, having the holes, are secured together using the bolt and nut.

The problem with this system is that the nut and bolt configuration is typically parallel to the pipe and due to this configuration it is often difficult to insert the bolt and secure the nut to the bolt. Often times there are numerous pipes that are placed adjacent to each other and due to the close proximity of the pipes it is difficult to insert and secure the nut to the bolt. Also, it is often ergonomically awkward to secure the nut to the bolt due to fact that the hangar is in an elevated position or is in difficult to reach arrangement when not in an elevated position. In many cases it would be beneficial to have a hangar designed to allow more easy access to the bolt and nut configuration and it would also be beneficial to have a way to secure the hangar parts together without using a nut and bolt. The present invention is designed to resolve all of the above issues by providing a hangar that allows more easily access to insert a bolt and to secure the two parts together and a means to secure the two mating parts without using a nut.

### SUMMARY OF THE INVENTION

To solve the above problems and to achieve the object noted above, the present disclosure is configured as follows.

A clamp that is angled at the top provides for a more easily connectable clamp and provides a more ergonomically usable clamp.

### BRIEF DESCRIPTION OF THE DRAWINGS

FIG. 1 is an elevated side view of the clamp of the present invention;

FIG. 2 is an elevated side, exploded view of the clamp of the present invention showing the two pieces along with the holes and bolt;

FIG. 3 is a side view of the clamp of the present invention showing the screw head connecting the two pieces together;

FIG. 4 is a side view of the clamp of the present invention from the screw bottom side showing the screw body connecting the two pieces together.

FIG. 5 is a side view of the clamp of the present invention with the screw connecting the two pieces together;

FIG. 6 is an opposite side view of the present invention with the screw connecting the two pieces together;

FIG. 7 is a top view of the clamp of the present invention with the screw attached;

FIG. 8 is a view of the clamp of the present invention from below;

FIG. 9 is an elevated side view of the clamp of the prior art;

FIG. 10 is a front view of the clamp of the prior art.

FIG. 10 is a front view of the clamp of the prior art.

FIG. 11 is an elevated view of the clamp of the present invention when connected to a pipe support;

FIG. 12 is an elevated view of the prior art clamp when connected to a pipe support;

### DETAILED DESCRIPTION OF THE EMBODIMENTS

Embodiments of a pipe clamp according to the present disclosure will be described below with reference to the accompanying drawings, but the present disclosure is not limited to these embodiments.

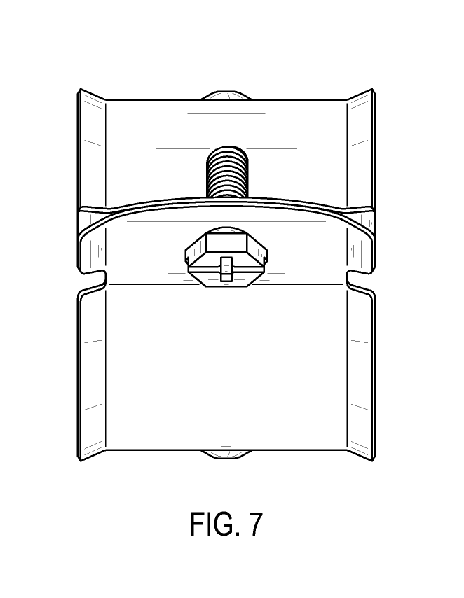

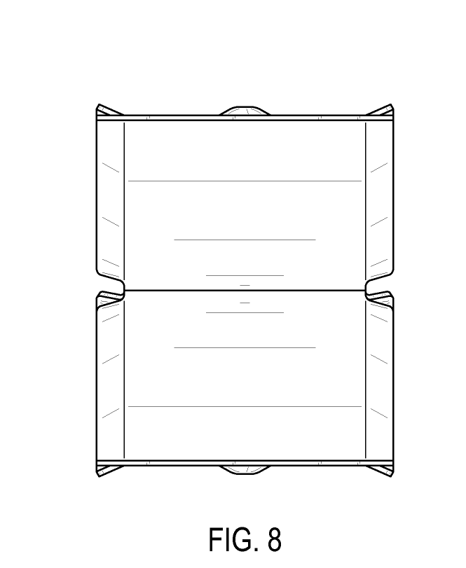

FIGS. 7, 8 and 12 show the prior art currently available. As can be seen, the clamp has two pieces with first ends that are connectable to a channel and two second ends that are securable to each other via a connecting means. As can be seen from FIGS. 7, 8 and 12, the second ends project upwardly from the sides that connect to the channel and are connected using a connecting means, such as a bolt or a bolt and nut.

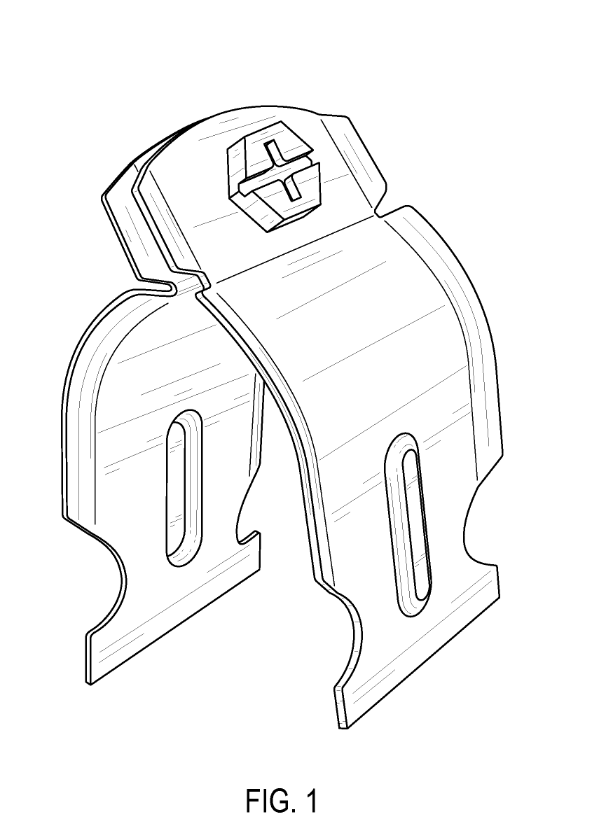

FIG. 1. shows the first embodiment of the present invention as assembled. As can be seen from the Fig. the invention has two pieces with each piece having two ends. The first and second pieces 20 and 30 have first ends 21, 31 that are configured to be placed and secured in a channel by indents 24, 34. Both the first and the second pieces 20, 30 have second ends 22, 32 that are connectable to each other using a bolt 40 or any other connectable means.

In the present invention both of the second ends 22, 32 of the first and second pieces 20, 30 are angled, as can be seen in FIG. 1. In addition, in the preferred embodiment, the first piece 20 has a hole 23 through the second end 22 and the hole 23 is a simple through hole that can be formed by punching, stamping, drilling or any other means to create a simple hole. The second end 32 of second piece 30 has a hole 33 that is threaded. The clamp is configured so that the bolt 40 may simply pass through common hole 23 and thereafter be screwed into threaded hole 33 so that the two pieces are then securely connected.

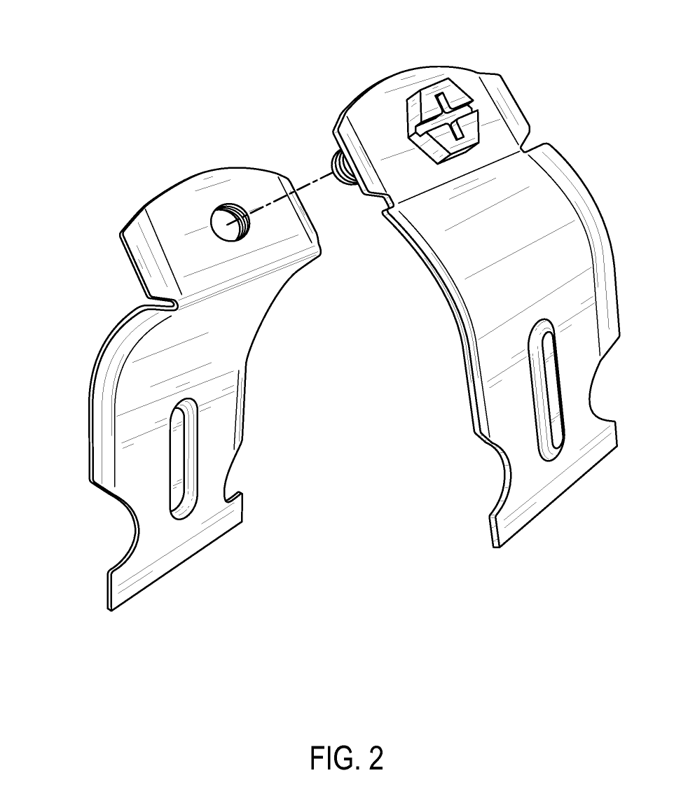

FIG. 2 shows the embodiment with the pieces separated. In this Fig. the bolt 40 is shown already having passed through the common hole 23 and is shown aligned with threaded hole 33. As can be seen, the pieces fit matingly together and are then secured by bolt 40.

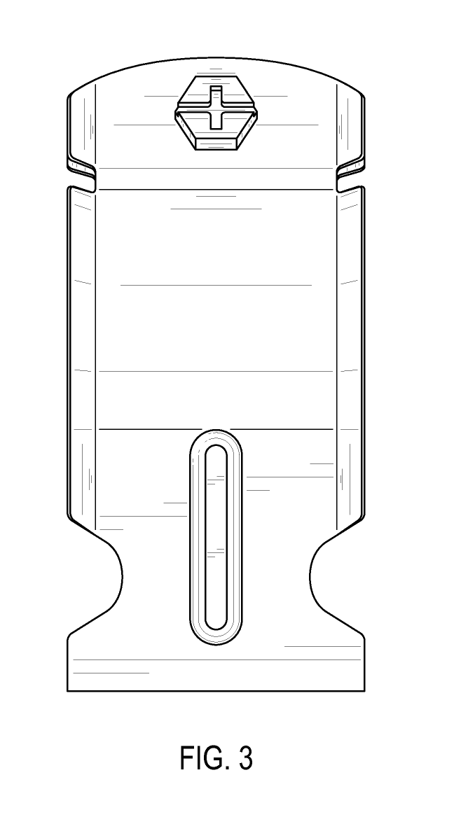

FIG. 3 is a view of the embodiment when looked at from the side where the bolt 40 is inserted into first piece 20.

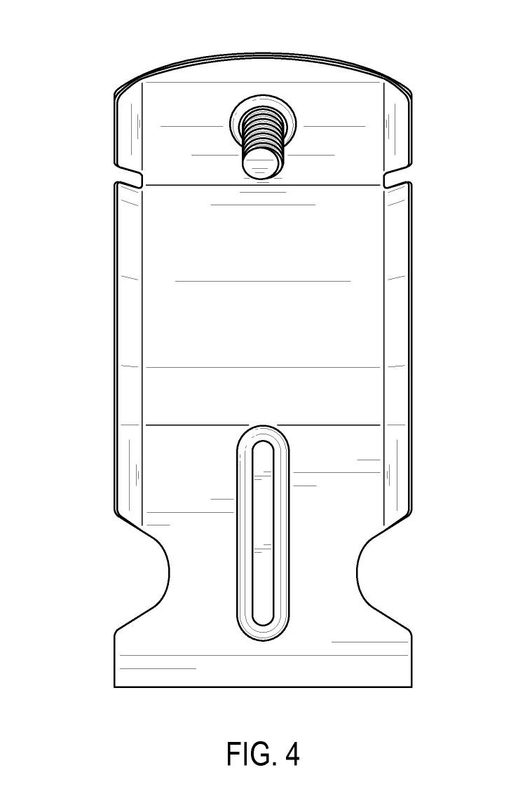

FIG. 4 is a view of the present embodiment when looked at from the side where the bolt 40 is screwed into threaded hole 33.

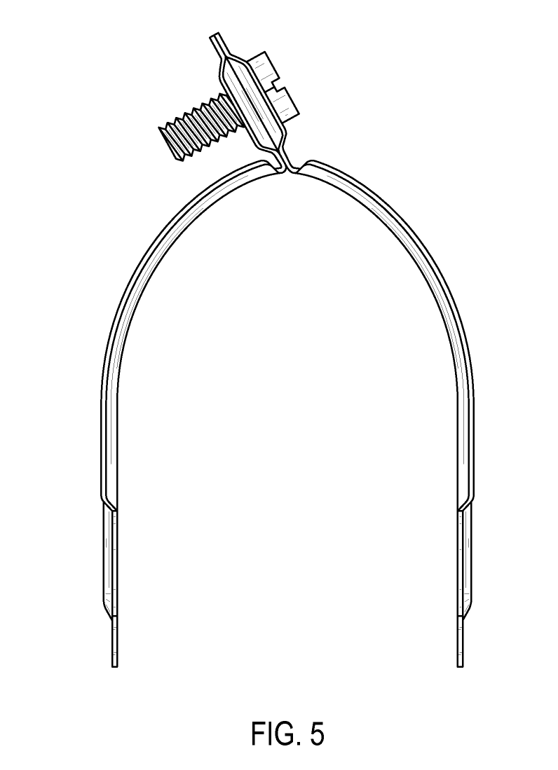

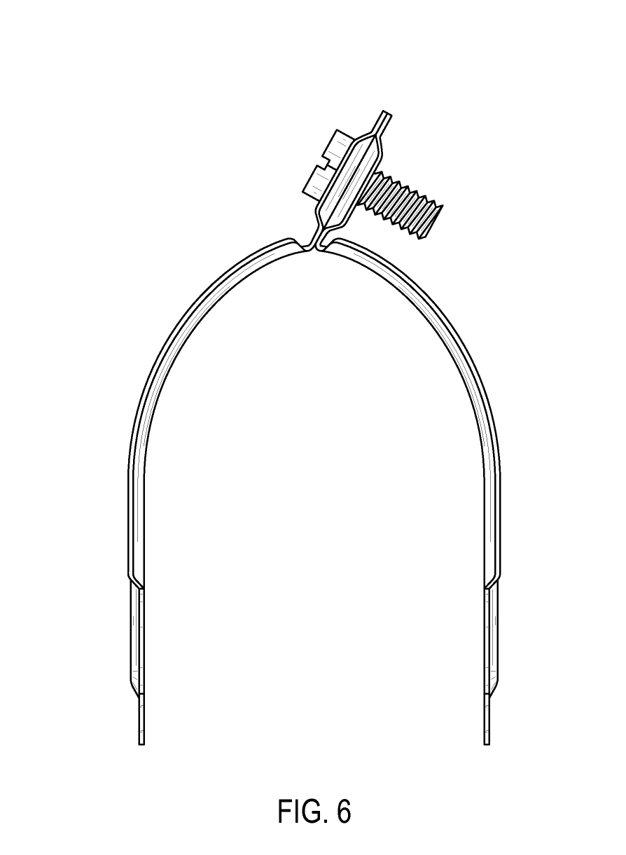

FIG. 5 is a view of the present embodiment when looked at from the front. The angle of both first piece and second piece is clearly shown in both this figure and FIG. 6.

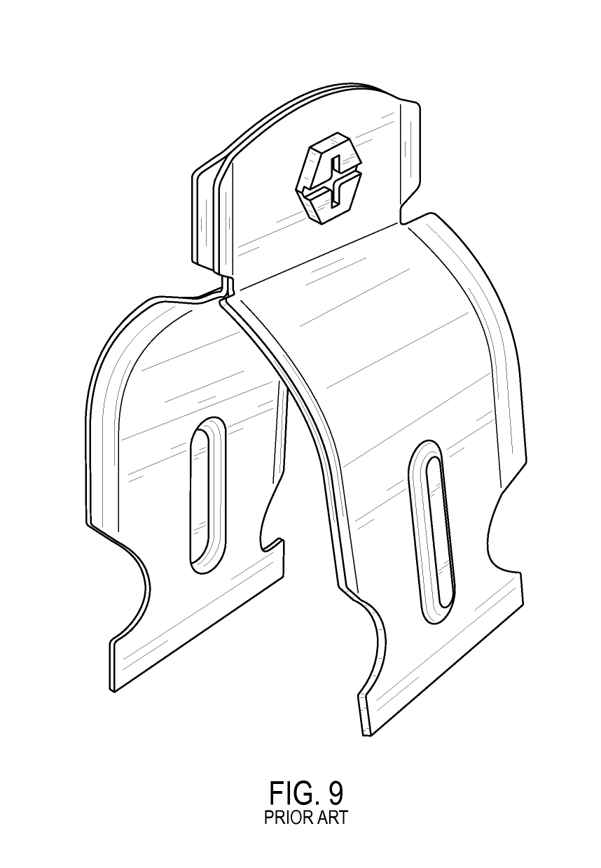

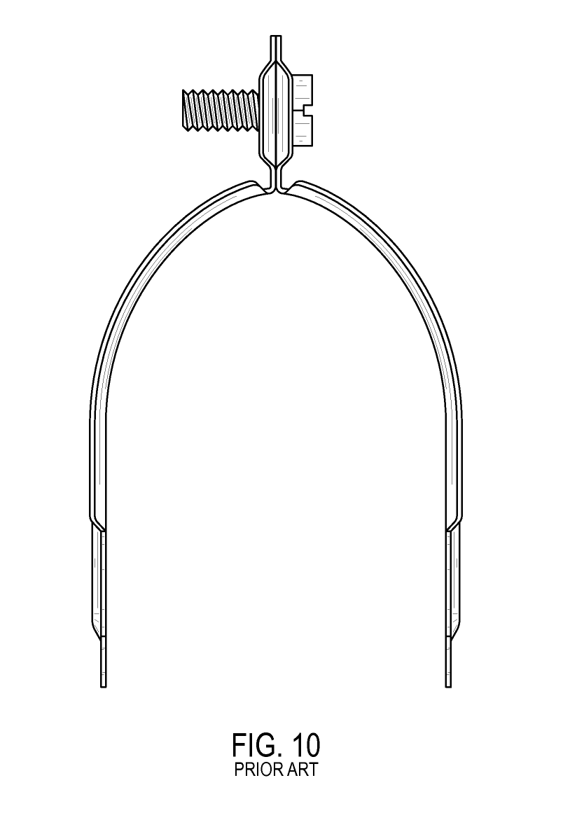

One of the most important and unique aspects of the present invention is the angle at the top of the clamp. Previously clamps were all straight, as shown in FIGS. 9, 10 and 12. The reason for this is quite simple and that is ease of manufacturing. Both of the first and second pieces of currently available clamps are identical. Therefore, manufacturing is limited to one piece. This obviously eliminates the need to have two different pieces and thus two different manufacturing processes. It also greatly reduces packaging error as the packager can never make a mistake by including two of the wrong pieces. The present invention would require slightly higher costs with respect to starting manufacturing as the pieces are different. However, after the initial costs are covered the manufacturing costs should be about the same. With respect to packaging it would require more attention to detail when packaging. However, packaging should theoretically not be any more expensive as it still only requires placing two pieces together.

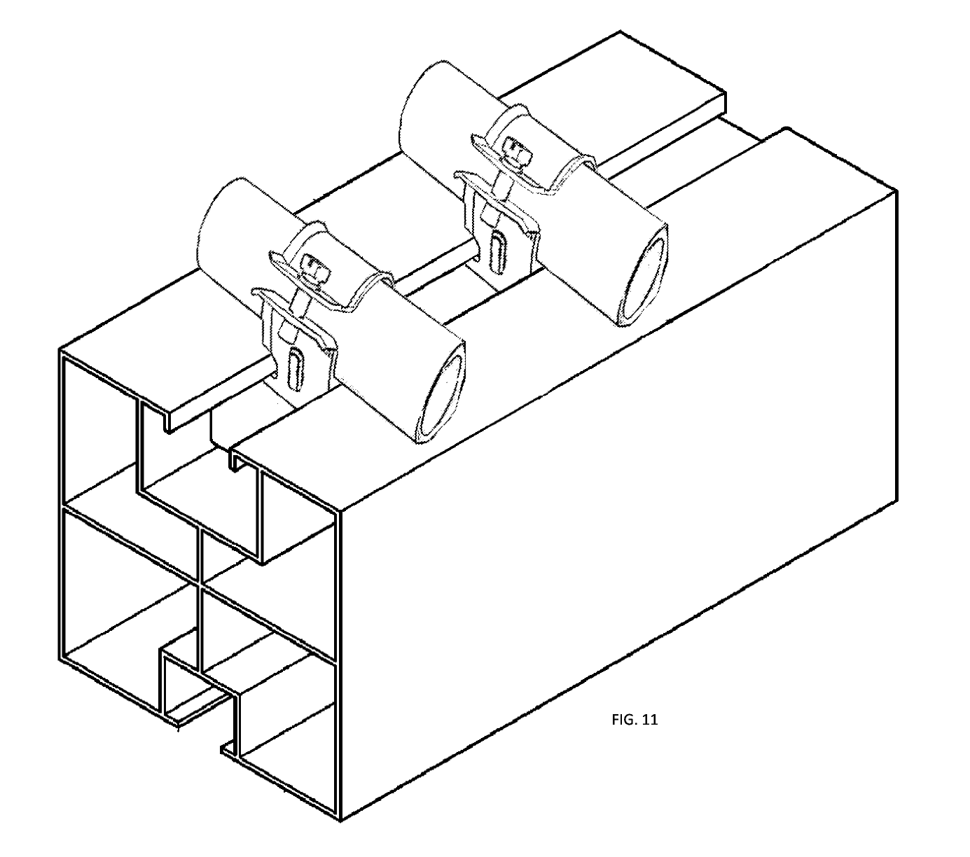

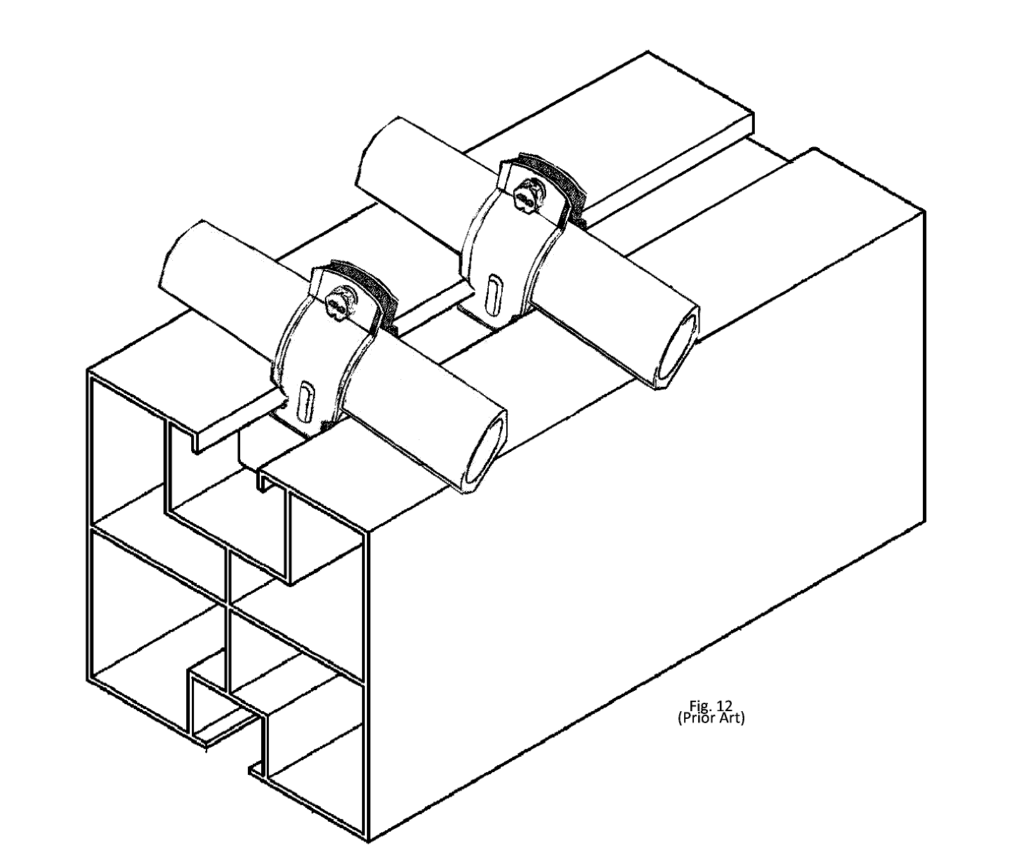

However, the benefits far outweigh the drawbacks of this design. As can be seen in Figures the angle provides substantial benefits over the standard, typical clamp. Often times there are numerous pipes lined up side by side. This can cause a potentially tight work space for an installer. As can be seen in the prior art in FIG. 12 when the pipes are positioned adjacent to each other it is difficult, if not impossible, to get a screw driver or wrench in between the pipes to tighten the bolt or bolt and nut. The side by side alignment of the pipes simply does allow space for easy accessibility and the perpendicular angle also makes it difficult to get a screw driver and socket into place. The present invention, on the other hand, provides an easy, unique alternative to this problem. FIG. 11 shows a plurality of pipes lined up adjacent to each other and also shows these pipes being secured using the pipe clamp of the present invention. As can be seen, angled ends 22, 32 allow the installer easy access to the bolt or bolt and nut and thus facilitate installation. In the preferred embodiment there is no need for the nut as the threaded hole 33 is used in the second piece 30 and thus the bolt 40 is simply passed through the common hole 23 and is then screwed into threaded hole 33 thus securing the first piece 20 to the second piece 30. Further, in the preferred embodiment, the end of bolt 40 is configured and designed to receive both a Phillips head or a straight head screwdriver and can further have the outside edges configured to be used with a common socket. Furthermore, the angles of pieces 20,30 may be varied in degree, and are all variations are acceptable as long as the bolt 40 is able to fit through both holes easily. This angled clamp minimizes installation time and thus minimizes installation costs. Therefore, the possible additional costs associated with manufacturing and packaging is far outweighed by the savings in time by the installer. Additionally, if the threaded hole is used there is no need to have a bolt or a socket to hold the bolt in place. This additionally minimizes production and packaging costs.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A pipe clamp comprising:
a first piece matingly connectable to a second piece; where
said first piece has
a first end configured for insertion into a channel; and
an angled second end with a hole therethrough;
said second piece has
a first end configured for insertion into said channel; and
an angled second end with a hole therethrough; where
said second ends of said first piece and said second piece are matingly configured to be secured to each other via said holes through said second ends of said first and said second pieces and where said holes matingly align with each other;
a connecting means to secure said first piece to said second piece via said holes; and
where both of said second ends are matingly angled.

2. The pipe clamp of claim one where the mating angle of said second end of said first piece is greater than 0 degrees and less than 90 degrees and where the mating angle of said second end of said second piece is greater than 90 degrees and less than 180.

3. The pipe clamp of claim one where said first and said second piece are connectable using a bolt and nut connection where said bolt is first inserted through said holes in said second ends of said first and said second pieces and where said nut is then screwed onto said bolt.

4. The pipe clamp of claim one where one of the holes of said first or said second pieces is a common hole and where the other of said first or said second pieces is a threaded hole that is mated to a bolt so that said bolt may be inserted through said common hole and then screwed through said threaded hole, thereby connecting said first and said second pieces with a single bolt.

5. A pipe clamp comprising:
a first piece matingly connectable to a second piece; where
said first piece is at an angle less than 90 degrees and has
a first end configured for insertion into a channel; and
a second end with a threaded hole therethrough;
said second piece is at an angle greater than 90 degrees and that has
a first end configured for insertion into said channel; and
a second end with a common hole therethrough; where
said second ends of said first piece and said second piece are matingly configured to be secured and attached to each other via said common hole and said threaded hole through said second ends of said first and said second pieces and where said holes are matingly and angularly configured to align with each other; and
where a bolt that is matingly configured to screw into said threaded hole is first passed through said common hole and is then screwed into said threaded hole until said first and said second pieces are securely connected.

6. The pipe clamp of claim five where at least one side of each of said first and said second pieces is angled.
